(19) United States
(12) Patent Application Publication
(10) Pub. No.: US 2026/0129335 A1
(43) Pub. Date: May 7, 2026

(54) EARPHONES

(71) Applicant: SHENZHEN SHOKZ CO., LTD., Shenzhen (CN)

(72) Inventors: Chu WANG, Shenzhen (CN); Jianhua XIE, Shenzhen (CN)

(73) Assignee: SHENZHEN SHOKZ CO., LTD., Shenzhen (CN)

(21) Appl. No.: 19/435,705

(22) Filed: Dec. 29, 2025

Related U.S. Application Data
(63) Continuation of application No. PCT/CN2024/096712, filed on May 31, 2024.

(51) Int. Cl. H04R 1/1025; H01Q 1/24; H01Q 1/48; H04R 1/06; H04R 1/10

(52) U.S. Cl. CPC H04R 1/1025; H01Q 1/24; H01Q 1/48; H04R 1/06; H04R 1/1041; H04R 2420/07

(57) ABSTRACT

An earphone includes a first housing assembly, a battery, and a circuit board assembly. The battery is configured in a columnar shape. The circuit board assembly includes a first rigid circuit board, a second rigid circuit board, and a first flexible circuit board. Along an axial direction of the battery, the first rigid circuit board and the second rigid circuit board are spaced apart at two ends of the battery. The first flexible circuit board connects the first rigid circuit board and the second rigid circuit board. Projections of the first rigid circuit board and the second rigid circuit board along the axial direction of the battery at least partially overlap an end surface of the battery. A projection of the first flexible circuit board along a radial direction of the battery at least partially overlaps a peripheral surface of the battery.

### CROSS-REFERENCE TO RELATED APPLICATIONS

This application is a continuation of International Application No. PCT/CN 2024/096712, filed on May 31, 2024, the contents of which are incorporated herein by reference to their entirety.

### TECHNICAL FIELD

The present disclosure relates to the field of electronic devices, and in particular, to an earphone.

### BACKGROUND

With the continuous popularization of electronic devices, the electronic devices have become indispensable social and entertainment tools in people's daily lives, and people's requirements for the electronic devices are also increasing. An earphone, as such an electronic device, has been widely used in people's daily lives. It may be used in conjunction with terminal devices such as mobile phones and computers to provide users with an auditory feast. According to a working principle of the earphone, it may generally be divided into an air conduction earphone and a bone conduction earphone; according to the way users wear the earphone, it may generally be divided into a headset earphone, an ear-clip earphone, and an in-ear earphone; according to the interaction way between the earphone and the electronic device, it may also be divided into a wired earphone and a wireless earphone. With increasing user requirements, current ear-clip earphones need to be configured with a large count of circuit components and an antenna assembly while also needing to be equipped with a battery of larger volume to meet power supply requirements. Therefore, how to reduce the spatial constraints of the battery on the antenna assembly and signal interference is a technical problem that urgently needs to be solved.

### SUMMARY

One or more embodiments of the present disclosure provide an earphone. The earphone comprises a first housing assembly configured to form a first accommodating space, and a battery and an antenna assembly provided in the first accommodating space. The antenna assembly is connected to a radio frequency (RF) unit configured to transmit an RF signal. The battery is configured in a columnar shape, the antenna assembly is spaced apart from the battery by a preset interval along an axial direction of the battery. A projection of the antenna assembly along the axial direction of the battery at least partially overlaps an end surface of the battery.

In some embodiments, the antenna assembly includes a first antenna section and a second antenna section. The first antenna section and the second antenna section are provided at two ends of the battery along the axial direction of the battery at an interval. Projections of the first antenna section and the second antenna section along the axial direction of the battery at least partially overlaps the end surface of the battery, respectively.

In some embodiments, in a wearing state, the axial direction of the battery intersects a horizontal plane of a human body.

In some embodiments, a ratio of an area of the first antenna section and a total projection area of the first antenna section along the axial direction of the battery is greater than or equal to 1.2. A ratio of an area of the second antenna section and a total projection area of the second antenna section along the axial direction of the battery is greater than or equal to 1.2.

In some embodiments, each of the first antenna section and the second antenna section is configured in a sheet shape. A main surface of the first antenna section is disposed to face an end surface of the battery adjacent to the first antenna section, and a main surface of the second antenna section is disposed to face an end surface of the battery adjacent to the second antenna section. An included angle between a normal direction of the main surface of the first antenna section and the axial direction of the battery, and an included angle between a normal direction of the main surface of the second antenna section and the axial direction of the battery are each less than or equal to 10 degrees.

In some embodiments, the first antenna section is connected to an RF port of the RF unit. The second antenna section is grounded. The RF unit simultaneously transmits or receives signals through the first antenna section and the second antenna section.

In some embodiments, the earphone further comprises a main control circuit board. The main control circuit board includes a first plate body and a second plate body that are opposite to each other and spaced apart along the axial direction of the battery. The main control circuit board further includes a flexible connecting board provided around a periphery of the battery along a radial direction of the battery. The flexible connecting board is at least configured to connect the first plate body and the second plate body to a common ground. The RF unit is provided on the first plate body. The first plate body is provided between the first antenna section and an end surface of the battery adjacent to the first antenna section. The second plate body is provided with a ground point. The second plate body is provided between the second antenna section and an end surface of the battery adjacent to the second antenna section. The second antenna section is connected to the ground point.

In some embodiments, the earphone further comprises a switching element, a detection element, and a control circuit. The detection element is configured to detect an operating parameter of the antenna assembly or detect a relative positional relationship between the first antenna section and the second antenna section. The control circuit is configured to control, based on a detection result of the detection element, the switching element to selectively connect one of the first antenna section and the second antenna section to an RF port of the RF unit.

In some embodiments, the earphone further comprises a second housing assembly, an ear-hook portion, and a speaker module. The second housing assembly is configured to form a second accommodating space. The speaker module is provided in the second accommodating space. The ear-hook portion connects the first housing assembly and the second housing assembly. In a wearing state, the first housing assembly and the second housing assembly form a clamping state on two sides of an auricle, the second housing assembly is located in a cavitas conchae, the ear-hook portion has a symmetry plane provided along a length direction of the ear-hook portion, and the axial direction of the battery intersects the symmetry plane.

In some embodiments, an antenna structure of the first antenna section is the same as an antenna structure of the second antenna section. The first antenna section and the second antenna section are symmetrically provided on two sides of the symmetry plane.

In some embodiments, the first antenna section has a first antenna length. The second antenna section has a second antenna length. A ratio of the first antenna length and the second antenna length is less than or equal to 1.2 and greater than or equal to 0.8.

The beneficial effects of the present disclosure are as follows. In the earphone of the present disclosure, the antenna assembly is spaced apart from the battery by the preset interval along the axial direction of the battery. Such arrangement can effectively improve the space utilization rate between the battery and the antenna assembly while effectively reducing the interference of the battery on the antenna assembly, thereby effectively improving the performance of the antenna assembly. Furthermore, the projection of the antenna assembly along the axial direction of the battery at least partially overlaps the end surface of the battery, which can effectively reduce the spatial occupancy rate of the antenna assembly in the radial direction of the battery, thereby effectively improving the space utilization rate of the antenna assembly and the battery assembly.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show only some embodiments of the present disclosure, and a person of ordinary skill in the art may derive other drawings from these accompanying drawings without creative efforts.

FIG. 1 is a front-view schematic diagram of an earphone after being worn on an ear of a large-ear population or a small-ear population according to some embodiments of the present disclosure;

FIG. 2 is a schematic diagram of a three-dimensional structure of the earphone shown in FIG. 1;

FIG. 3 is a schematic diagram of a structure of the earphone shown in FIG. 2 in direction A;

FIG. 4 is a schematic diagram of a three-dimensional structure of an ear-hook portion and an abutting portion of the earphone shown in FIG. 2;

FIG. 5 is a schematic diagram of an exploded structure of the ear-hook portion and the abutting portion shown in FIG. 4;

FIG. 6 is a schematic diagram of a three-dimensional structure of an embedded body shown in FIG. 5;

FIG. 7 is a schematic diagram of an exploded structure of the embedded body shown in FIG. 6;

FIG. 8 is a schematic diagram of a three-dimensional structure of a rigid bracket of the embedded body shown in FIG. 7; and

FIG. 9 is a schematic diagram of a three-dimensional structure of a second housing of the earphone shown in FIG. 5.

### DETAILED DESCRIPTION

The following describes the present disclosure in further detail with reference to the accompanying drawings and embodiments. It should be specially noted that the following embodiments are merely used to illustrate the present disclosure, but not to limit the scope of the present disclosure. Similarly, the following embodiments are only part of the embodiments of the present disclosure rather than all of the embodiments. All other embodiments obtained by a person of ordinary skill in the art based on the embodiments of the present disclosure without creative efforts shall fall within the protection scope of the present disclosure.

The mention of “embodiment” in the present disclosure means that a specific feature, structure, or characteristic described in connection with the embodiment may be included in at least one embodiment of the present disclosure. Those skilled in the art explicitly and implicitly understand that the embodiments described in the present disclosure may be combined with other embodiments.

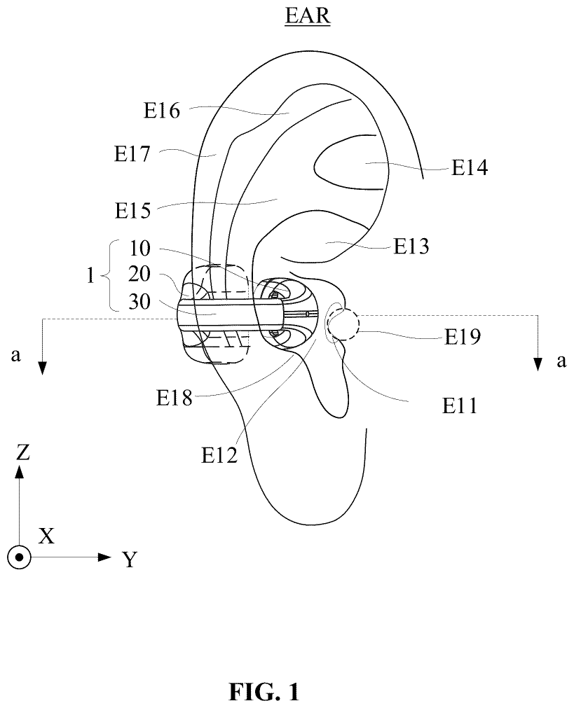

With reference to FIG. 1, an ear of a user may include physiological parts such as an external auditory canal E11, a cavitas conchae E12, a cymba conchae E13, a triangular fossa E14, an antihelix E15, a scaphoid fossa E16, an auricle E17, and an antitragus E18. Although the external auditory canal 101 has a certain depth and extends to a tympanic membrane of the ear, for ease of description and with reference to FIG. 1, in the present disclosure, unless otherwise specified, the external auditory canal 101 specifically refers to an entrance thereof away from the tympanic membrane (that is, an ear hole). Furthermore, the physiological parts such as the cavitas conchae E12, the cymba conchae E13, and the triangular fossa E14 have a certain volume and depth; and the cavitas conchae E12 is directly connected to the external auditory canal E11, that is, it may be simply considered that the ear hole is located at a bottom of the cavitas conchae E12.

Furthermore, around the external auditory canal of the ear, there is also a tragus E19. Compared to the physiological parts such as the cavum concha E12, the cymba concha E13, and the triangular fossa E14, which have the certain volume and depth in three-dimensional space, that is, these physiological parts are recessed toward a rear side of the ear along a direction closer to the user's head, the tragus E19 protrudes toward a front side of the ear along a direction away from the user's head. “The front side of the ear” is a concept relative to “the rear side of the ear”, where the former refers to a side of the ear away from the head, as shown in FIG. 1, and the latter refers to a side of the ear toward the head, both of which are for the ear of the user.

Furthermore, different users may have individual differences, leading to variations in the shape, size, and other dimensions of the ear. To facilitate description and reduce (or even eliminate) individual differences among the users, unless otherwise specified, the present disclosure will mainly use an ear model with a standard shape and a standard size as a reference to further describe a wearing manner of an acoustic device in different embodiments on the ear model. For example, based on ANSI S3.36, S3.25, and IEC 603187 standards, a simulator including a head and its (left and right) ears, such as GRAS 45BC KEMAR, may be manufactured as a reference for wearing the acoustic device, thereby presenting the scenario where most users normally wear the acoustic device. Merely by way of example, the reference ear may have the following relevant characteristics: a size of a projection of the auricle on a sagittal plane in a vertical axis direction may be in a range of 49.5 mm to 74.3 mm, and a size of a projection of the auricle on a sagittal plane in a sagittal axis direction may be in a range of 36.6 mm to 55 mm. Therefore, in the present disclosure, descriptions such as “the user wears” and “in a wearing state” may refer to the acoustic device described in the present disclosure being worn on the ear of the simulator. Of course, considering individual differences among users, the structure, shape, size, thickness, etc. of one or more parts of the ear may vary. To meet the needs of different users, the acoustic device may be differentially designed, and differential designs may be reflected in that feature parameters of one or more structures of the acoustic device (for example, a sounding portion 100, a connecting portion 200, etc., below) may have values in different ranges to adapt to different ears.

It should be noted that in fields such as medicine and anatomy, three basic planes of a human body are defined: the sagittal plane, a coronal plane, and the horizontal plane, as well as three basic axes: the sagittal axis, a coronal axis, and the vertical axis. The sagittal plane refers to a plane perpendicular to the ground made along an anterior-posterior direction of the body, which divides the body into left and right parts. The coronal plane refers to a plane perpendicular to the ground made along a left-right direction of the body, which divides the body into anterior and posterior parts. The horizontal plane refers to a plane parallel to the ground made along a superior-inferior direction of the body, which divides the body into upper and lower parts. Correspondingly, the sagittal axis refers to an axis along the anterior-posterior direction of the body and perpendicular to the coronal plane. The coronal axis refers to an axis along the left-right direction of the body and perpendicular to the sagittal plane. The vertical axis refers to an axis along the superior-inferior direction of the body and perpendicular to the horizontal plane. Furthermore, “the front side of the ear” described in the present disclosure is a concept relative to “the rear side of the ear”, where the former refers to a side of the ear away from the head, and the latter refers to the side of the ear toward the head, both of which are for the ear of the user. By observing the ear of the aforementioned simulator along the direction of the coronal axis of the human body, the front side outline of the ear as shown in FIG. 1 may be obtained. Based on this, combined with FIG. 1, the three directions X, Y, and Z may be simply regarded as the coronal axis, the sagittal axis, and the vertical axis of the human body, respectively; the three planes XY, XZ, and YZ may be simply regarded as the horizontal plane, the coronal plane, and the sagittal plane of the human body, respectively.

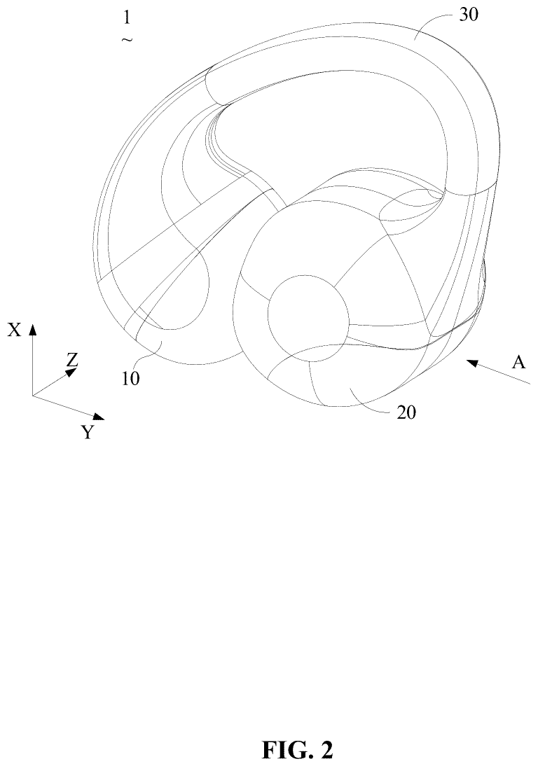

Referring to FIGS. 2- to 4, the present disclosure proposes an earphone 1, which is an ear-clip earphone 1. The earphone 1 includes a speaker module 10 inserted into a cavitas conchae E12 of a wearer, an abutting portion 20 for abutting against the rear of the ear of the wearer, and an ear-hook portion 30 connected between the speaker module 10 and the abutting portion 20. The speaker module 10 is a sound playback device configured to convert an electrical signal into a sound signal and play it to the wearer, and in a wearing state, it is located in the cavitas conchae E12. Specifically, the abutting portion 20 and the speaker module 10 form a clamping state to abut against an outer side wall of the cavitas conchae E12 and an inner side wall of the earphone cavity E12, respectively, so as to clamp and wear the entire earphone 1 on the ear of the user. In some embodiments, the abutting portion 20 may be used as a battery compartment for installing the battery 222 or other components. Of course, the abutting portion 20 may not be used as the battery compartment, and the battery 222 may be installed in the speaker module 10. The ear-hook portion 30 is a component that provides a clamping force. Two ends of the ear-hook portion 30 are connected to the speaker module 10 and the abutting portion 20, respectively. In the wearing state, the ear-hook portion 30 bypasses an auricle E17 so that the speaker module 10 and the abutting portion 20 are located on two sides of the human ear along a coronal axis of the human body, and the speaker module 10 extends into the cavitas conchae E12 to transmit sound to an ear canal.

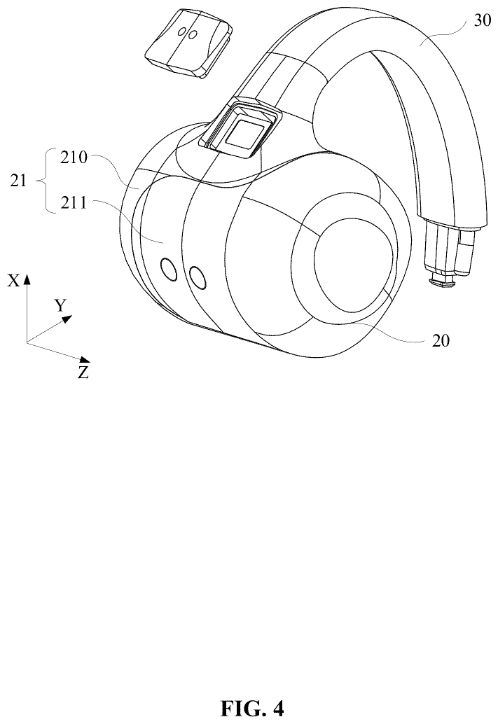

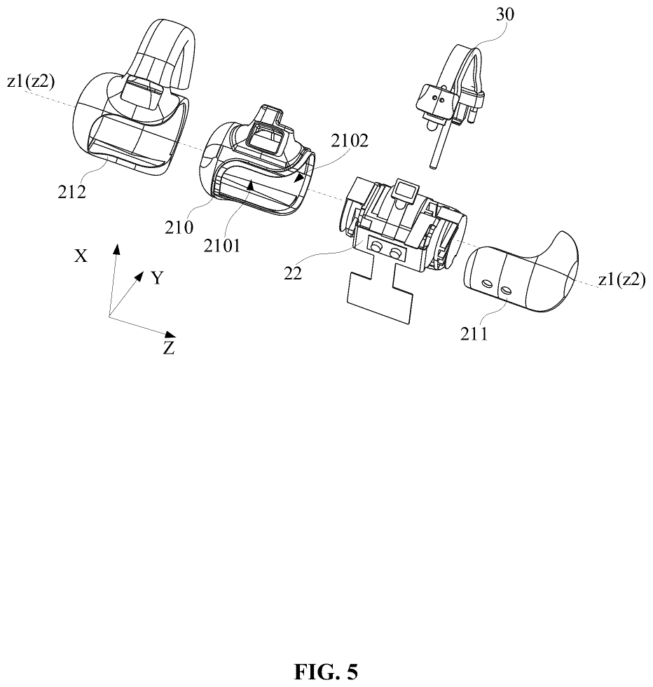

Optionally, as shown in FIGS. 4 and 5, in some embodiments, the abutting portion 20 includes a first housing assembly 21. The first housing assembly 21 includes a first housing 210. The first housing 210 forms an accommodating cavity 2101 with a first opening 2102. The earphone 1 includes an embedded body 22 embedded in the accommodating cavity 2101 via the first opening 2102. The embedded body 22 may be a corresponding element assembly on the earphone 1 that needs to be installed in the accommodating cavity 2101. Thus, by integrating the elements that need to be installed in the accommodating cavity 2101 into the embedded body 22 and then embedding the embedded body 22 into the accommodating cavity 2101 via the first opening 2102, the assembly efficiency and the assembly convenience of the earphone 1 can be effectively improved. Furthermore, the first housing assembly 21 further includes a second housing 211. The second housing 211 may cooperate with the first housing 210 to cover the first opening 2102, thereby sealing the accommodating cavity 2101. Thus, the first housing assembly 21 forms a sealed accommodating cavity 2101 through the cooperation of the first housing 210 and the second housing 211. On one hand, this can effectively provide a sealed environment for the embedded body 22 disposed in the accommodating cavity 2101, thereby effectively improving the working stability and the service life of the embedded body 22. On the other hand, it can also effectively improve the assembly convenience and the assembly efficiency of the earphone 1.

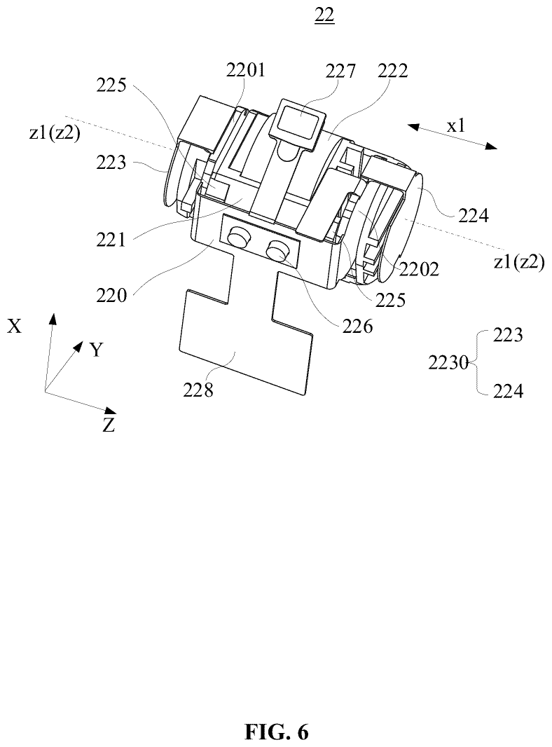

Optionally, as shown in FIG. 6, in some embodiments, the embedded body 22 includes a battery 222, a circuit board assembly 220, and a rigid bracket 221. Specifically, in some embodiments, the elements that need to be installed in the accommodating cavity 2101 at least include the battery 222 and the circuit board assembly 220. The battery 222 and the circuit board assembly 220 are disposed on the rigid bracket 221 and remain relatively fixed to the rigid bracket 221 to form the embedded body 22, which is then embedded into the accommodating cavity 2101 via the first opening 2102 to achieve assembly. This can effectively improve the assembly efficiency and the assembly convenience of installing elements such as the battery 222 and the circuit board assembly 220 into the accommodating cavity 2101. Moreover, the rigid bracket 221 may provide rigid support for the circuit board assembly 220 and the battery 222. During the assembly process, the circuit board assembly 220 and the battery 222 may be spatially arranged on the rigid bracket 221, and then the circuit board assembly 220 and the battery 222 are disposed in the accommodating cavity 2101 through the rigid bracket 221. This can effectively reduce the probability of damage to the circuit board assembly 220 and the battery 222 during the assembly process, thereby effectively improving the production yield of the earphone 1. It should be noted that in some embodiments, the circuit board assembly 220 is also referred to as a main control circuit board.

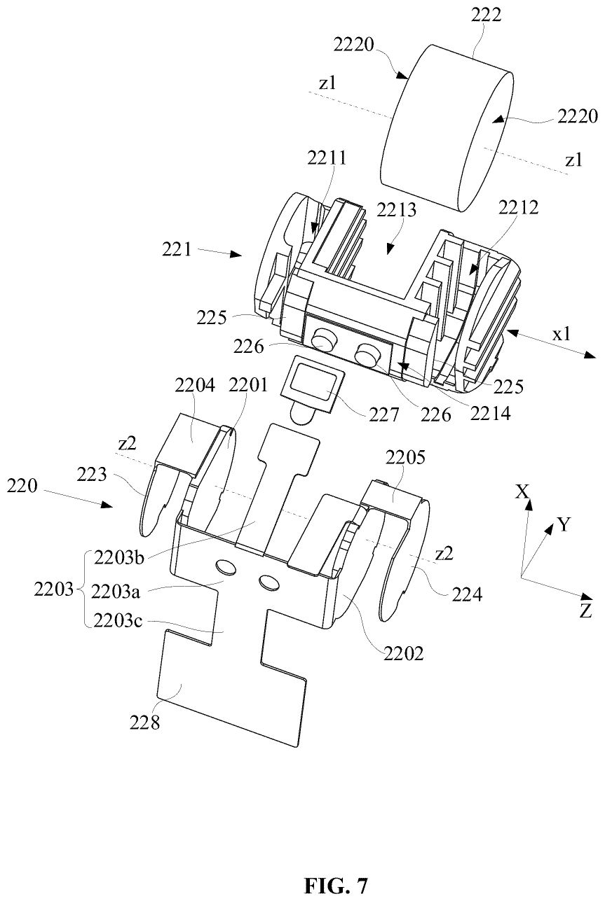

Optionally, as shown in FIGS. 6 and 7, in some embodiments, the circuit board assembly 220 includes a rigid circuit board (e.g., a first rigid circuit board 2201 or a second rigid circuit board 2202 shown in FIGS. 6 and 7). The rigid circuit board is a plate-like structure of the circuit board assembly 220 for integrating circuit elements. The circuit elements may include the main control circuit and sensors. The circuit board assembly 220 may be provided with at least one rigid circuit board to effectively improve the integration degree of the circuit elements of the earphone 1, thereby ensuring the functional diversity of the earphone 1 while effectively improving the space utilization rate of the earphone 1. Furthermore, the rigid bracket 221 is provided with a battery accommodating area 2213 and at least one circuit board accommodating area. The battery accommodating area 2213 has a second opening (not labeled), and the circuit board accommodating area has a third opening (not labeled). The rigid circuit board and the battery 222 are respectively disposed in the circuit board accommodating area and the battery accommodating area 2213 on the rigid bracket 221. Such arrangement can enable the rigid bracket 221 to provide better physical protection for the rigid circuit board and the battery 222, thereby effectively protecting the circuit elements on the rigid circuit board and the battery 222, thus effectively reducing the probability of damage to the circuit board assembly 220 and the battery 222 during the assembly process, and further effectively improving the production yield of the earphone 1. The rigid circuit board and the battery 222 are separately disposed in the battery accommodating area 2213 and the circuit board accommodating area, which can also effectively improve the heat dissipation efficiency of the battery 222 and the rigid circuit board, thereby effectively improving the working stability of the battery 222 and the circuit elements on the rigid circuit board.

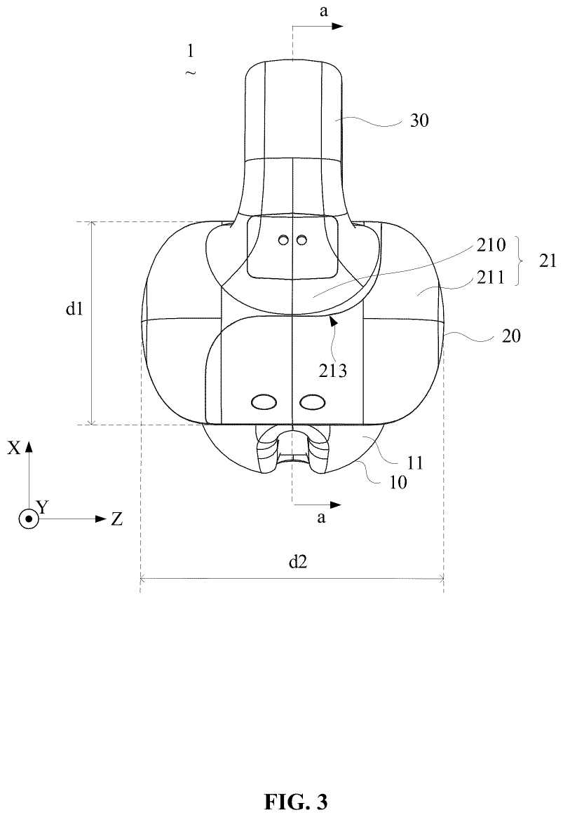

As shown in FIGS. 2 and 3, the ear-hook portion 30 has a symmetry plane a-a provided along a length direction of the ear-hook portion 30, and has an x1 direction perpendicular to the symmetry plane a-a. The x1 direction is parallel to a z-axis in the figure. The battery accommodating area 2213 and the at least one circuit board accommodating area are spaced apart from each other along the x1 direction. The second opening and the third opening are configured to allow the battery 222 and the rigid circuit board to be placed in the battery accommodating area 2213 and the circuit board accommodating area respectively along a direction perpendicular to the x1 direction. Such arrangement can effectively avoid interference of the spatial position of the battery accommodating area 2213 with the installation process of the rigid circuit board, and avoid interference of the spatial position of the circuit board accommodating area with the installation process of the battery 222, thereby effectively improving the assembly efficiency of the battery 222 and the rigid circuit board.

Preferably, as shown in FIGS. 6 and 7, in some embodiments, the circuit board assembly 220 may include two or more rigid circuit boards. Correspondingly, the rigid bracket 221 is formed with two or more spaced circuit board accommodating areas along the x1 direction. The two or more rigid circuit boards are respectively disposed in the corresponding circuit board accommodating areas. This can effectively improve the heat dissipation efficiency of each rigid circuit board, thereby improving the working stability of the circuit elements on each rigid circuit board. For example, in the embodiment, the circuit board assembly 220 includes two rigid circuit boards, which are the first rigid circuit board 2201 and the second rigid circuit board 2202, respectively. Correspondingly, the rigid bracket 221 is formed with two spaced circuit board accommodating areas along the x1 direction, which are a first circuit board accommodating area 2211 and a second circuit board accommodating area 2212, respectively. The first rigid circuit board 2201 and the second rigid circuit board 2202 are respectively disposed in the first circuit board accommodating area 2211 and the second circuit board accommodating area 2212. This can effectively improve the working stability of the circuit elements on the first rigid circuit board 2201 and the circuit elements on the second rigid circuit board 2202.

It should be noted that, unless otherwise specified in the present disclosure, the rigid circuit board may refer to any one of the first rigid circuit board 2201 or the second rigid circuit board 2202. The corresponding circuit board accommodating area may refer to any one of the first circuit board accommodating area 2211 or the second circuit board accommodating area 2212. In some embodiments, the first rigid circuit board 2201 is also referred to as a first plate body, and the second rigid circuit board 2202 is also referred to as a second plate body.

Preferably, as shown in FIG. 7, in some embodiments, the battery 222 is configured in a columnar shape, e.g., a square body with a square or rectangular bottom surface or a cylinder with a circular bottom surface. An axial direction z1 of the battery 222 is defined as an extension direction perpendicular to a bottom surface of the columnar. For example, in the embodiment, the battery 222 is configured as a cylinder, and the axial direction z1 is defined as an extension direction perpendicular to an end surface 2220 of the battery 222. Furthermore, an included angle between the x1 direction and the axial direction z1 of the battery 222 is set to be greater than or equal to 0° and less than or equal to 30°. This can make the x1 direction as parallel as possible to the axial direction z1 of the battery 222, thereby effectively improving the space utilization rate of the rigid bracket 221 while effectively reducing the spatial volume of the rigid bracket 221, and thus effectively reducing the spatial volume of the embedded body 22. Furthermore, the rigid circuit board has a main surface of a planar-like shape for disposing of the circuit elements. The rigid circuit board has a maximum dimension in an extension direction of the main surface. The main surface of the rigid circuit board is disposed to face or away from the end surface 2220 of the battery 222. Such arrangement can effectively reduce the spatial occupancy rate of the rigid circuit board and the battery 222 in the x1 direction, thereby effectively improving the space utilization rate of the rigid bracket 221, and thus effectively reducing the spatial volume of the embedded body 22.

Optionally, as shown in FIG. 7, in some embodiments, an included angle between the main surface of the rigid circuit board and the x1 direction is greater than or equal to 80° and less than or equal to 90°. Such arrangement can make the main surface of the rigid circuit board as perpendicular as possible to the x1 direction, thereby reducing the spatial occupancy rate of the rigid circuit board and the battery 222 in the x1 direction, thus effectively improving the space utilization rate of the rigid bracket 221, and thereby effectively reducing the spatial volume of the embedded body 22.

Preferably, as shown in FIG. 7, in some embodiments, an included angle between a normal direction z2 of the main surface of the rigid circuit board and the axial direction z1 of the battery 222 is set to be less than or equal to 7 degrees. This can make the normal direction z2 as parallel as possible to the axial direction z1 of the battery 222, effectively reducing the spatial occupancy rate of the rigid circuit board and the battery 222 in the x1 direction, thereby effectively improving the space utilization rate of the rigid bracket 221, and thus effectively reducing the spatial volume of the embedded body 22.

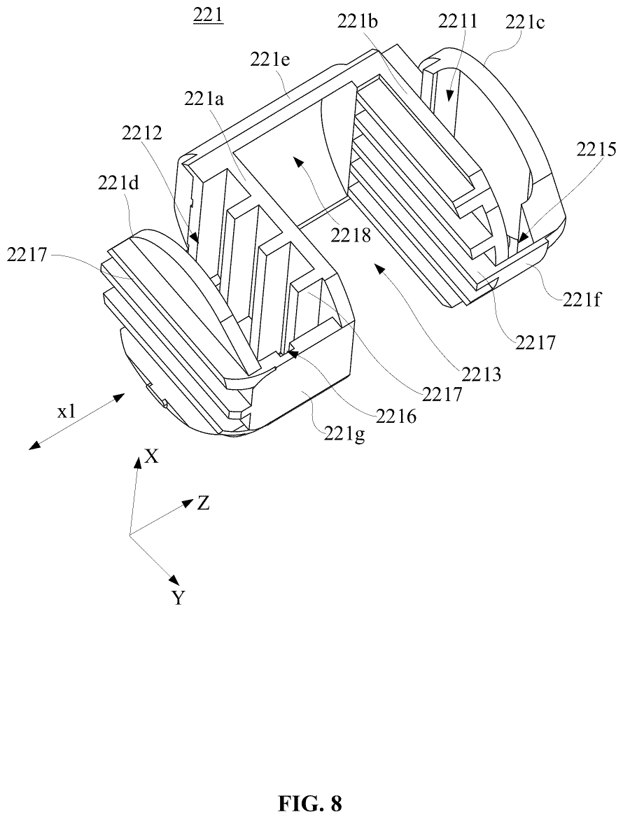

Optionally, as shown in FIG. 8, in some embodiments, the rigid bracket 221 may be formed by connecting a plurality of plate-like members. This can ensure the structural strength of the rigid bracket 221 while effectively reducing the overall mass of the rigid bracket 221, thereby effectively reducing the overall mass of the earphone 1. Specifically, in some embodiments, the rigid bracket 221 includes a first end plate 221a, a second end plate 221b, a third end plate 221c, a fourth end plate 221d, a first side plate 221e, a second side plate 221f, and a third side plate 221g. The first end plate 221 a, the second end plate 221 b, and the third end plate 221c are sequentially spaced apart along the x1 direction. The third end plate 221c is located on a side of the second end plate 221b away from the first end plate 221a. The first side plate 221e connects the first end plate 221a and the second end plate 221b to form the battery accommodating area 2213 between the first end plate 221a and the second end plate 221b. The second side plate 221f connects the second end plate 221b and the third end plate 221c to form the first circuit board accommodating area 2211 between the second end plate 221b and the third end plate 221c. The fourth end plate 221d is located on a side of the first end plate 221a away from the second end plate 221b and is spaced from the first end plate 221a along the x1 direction. The third side plate 221g connects the fourth end plate 221 d and the first end plate 221a to form the second circuit board accommodating area 2212. Such arrangement can ensure the structural strength of the rigid bracket 221 while effectively reducing the overall mass of the rigid bracket 221.

Preferably, as shown in FIG. 8, the rigid bracket 221 is an integrally formed member, that is, the rigid bracket 221 may be manufactured by an integral molding process. A plurality of rib structures 2217 may be provided on side walls of the first end plate 221a, the second end plate 221b, the third end plate 221c, and the fourth end plate 221d along the x1 direction, respectively. Thus, the rib structures 2217 can effectively improve the structural strength of the first end plate 221a, the second end plate 221b, the third end plate 221c, and the fourth end plate 221d. Moreover, the first end plate 221a, the second end plate 221b, the third end plate 221c, and the fourth end plate 221d are plate-like structures. After the integral molding process is completed, the first end plate 221a, the second end plate 221b, the third end plate 221c, and the fourth end plate 221d need to be cooled. The rib structures 2217 can effectively improve the heat dissipation uniformity of the first end plate 221a, the second end plate 221b, the third end plate 221c, and the fourth end plate 221d, thereby effectively preventing the first end plate 221a, the second end plate 221b, the third end plate 221c, and the fourth end plate 221d from generating excessive deformation, collapse, or other undesirable phenomena during the cooling process, thus effectively improving the production yield of the rigid bracket 221.

Preferably, as shown in FIGS. 6 to 8, in some embodiments, projections of the first end plate 221a and the second end plate 221b along the axial direction z1 of the battery 222 overlap the end surface 2220 of the battery 222, respectively. Such arrangement can effectively reduce the spatial occupancy rate of the battery 222 on the rigid bracket 221 in the x1 direction, thereby effectively reducing the overall volume of the rigid bracket 221. Furthermore, on a reference cross-section perpendicular to the axial direction z1 of the battery 222, an inner side 2218 of the first side plate 221e is configured in an arc shape adapted to an outer peripheral surface of the battery 222. This allows the inner side 2218 of the first side plate 221e to closely fit with the outer peripheral side surface of the battery 222, thereby effectively improving the connection stability between the battery 222 and the first side plate 221e.

Optionally, as shown in FIGS. 6 to 8, in some embodiments, an inner side of the second side plate 221f is provided with a first embedding groove 2215, and an inner side of the third side plate 221g is provided with a second embedding groove 2216. The first rigid circuit board 2201 is embedded in the first embedding groove 2215, and the second rigid circuit board 2202 is embedded in the second embedding groove 2216. Such arrangement allows the first rigid circuit board 2201 and the second rigid circuit board 2202 to be connected and fixed to the second side plate 221 f and the third side plate 221g through the first embedding groove 2215 and the second embedding groove 2216, respectively, thereby effectively improving the connection stability between the first rigid circuit board 2201 and the rigid bracket 221 and between the second rigid circuit board 2202 and the rigid bracket 221, effectively reducing the probability of shaking of the first rigid circuit board 2201 and the second rigid circuit board 2202, and thus effectively improving the working stability of the circuit board assembly 220.

Preferably, in some embodiments, an interval distance between the second end plate 221b and the third end plate 221c is greater than an interval distance between the first end plate 221a and the fourth end plate 221d. Such arrangement allows circuit elements with a larger spatial occupancy rate in the x1 direction to be integrated on the first rigid circuit board 2201, and circuit elements with a smaller spatial occupancy rate in the x1 direction to be integrated on the second rigid circuit board 2202, thereby effectively improving the space utilization rate of the rigid bracket 221 in the x1 direction and effectively reducing the spatial volume of the rigid bracket 221.

Preferably, as shown in FIGS. 6 and 7, the circuit board assembly 220 further includes a first flexible circuit board 2203 connecting the first rigid circuit board 2201 and the second rigid circuit board 2202. In some embodiments, the circuit elements on the first rigid circuit board 2201 may be electrically connected to the circuit elements on the second rigid circuit board 2202 through the first flexible circuit board 2203 to achieve information interaction between the corresponding circuit elements. The first flexible circuit board 2203 is attached to a side of the first side plate 221e away from the battery accommodating area 2213. Such arrangement allows the first side plate 221e to provide rigid support for the first flexible circuit board 2203, effectively reducing the probability of damage to the first flexible circuit board 2203, and thus effectively improving the working stability of the circuit board assembly 220.

Preferably, in some embodiments, a ground point is further provided on the first rigid circuit board 2201 or the second rigid circuit board 2202. The first rigid circuit board 2201 and the second rigid circuit board 2202 are connected to a common ground through the first flexible circuit board 2203. For example, in some embodiments, a radio frequency (RF) unit for transmitting an RF signal is provided on the first rigid circuit board 2201 (wherein the RF unit is a component for connecting to an antenna assembly, specifically see the following content), and the ground point is provided on the second rigid circuit board 2202.

It should be noted that in some embodiments, the first flexible circuit board 2203 is also referred to as a flexible connecting board.

Preferably, as shown in FIGS. 6 and 7, in some embodiments, along the axial direction z1 of the battery 222, the first rigid circuit board 2201 and the second rigid circuit board 2202 are provided at two ends of the battery 222 at an interval. For example, as described above, the first rigid circuit board 2201 is disposed in the first circuit board accommodating area 2211 and the second circuit board accommodating area 2212, respectively. Such arrangement can effectively ensure the board surface area of the first rigid circuit board 2201 and the second rigid circuit board 2202 (that is, an area of the main surface for disposing the circuit elements, in some embodiments, also referred to as an area of the rigid circuit board), so that the circuit board assembly 220 can integrate more circuit elements while effectively improving a space utilization rate between the battery 222 and the circuit board assembly 220.

Furthermore, projections of the first rigid circuit board 2201 and the second rigid circuit board 2202 along the axial direction z1 of the battery 222 at least partially overlap the end surface 2220 of the battery 222, and a projection of the first flexible circuit board 2203 along a radial direction of the battery 222 at least partially overlaps a peripheral surface of the battery 222. Based on this, the space utilization rate between the battery 222 and the circuit board assembly 220 can be further improved.

Preferably, as shown in FIGS. 6 and 7, in some embodiments, a ratio of an area of the first rigid circuit board 2201 to a total projection area of the first rigid circuit board 2201 along the axial direction z1 of the battery 222 is greater than or equal to 80%, and a ratio of an overlapping area between the second rigid circuit board 2202 and the end surface 2220 of the battery 222 to a total projection area of the second rigid circuit board 2202 along the axial direction z1 of the battery 222 is greater than or equal to 80%. Such arrangement can effectively improve the space utilization rate between the rigid circuit board and the battery 222. Preferably, in some embodiments, the area of the rigid circuit board may be equal to the total projection area of the rigid circuit board along the axial direction z1 of the battery 222, that is, the ratio of the area of the rigid circuit board to the total projection area of the rigid circuit board along the axial direction z1 of the battery 222 is equal to 1.

Preferably, as shown in FIG. 6 and7, in some embodiments, an included angle between a normal direction z2 of the main surface of the first rigid circuit board 2201 and the axial direction z1 of the battery 222 and an included angle between a normal direction z2 of the main surface of the second rigid circuit board 2202 and the axial direction z1 of the battery 222 are both less than or equal to 10°. Such arrangement makes the main surface of the first rigid circuit board 2201 and the main surface of the second rigid circuit board 2202 as parallel as possible to the two end surfaces of the battery 222, respectively, thereby effectively improving the space utilization rate among the first rigid circuit board 2201, the second rigid circuit board 2202, and the battery 222. Specifically, the rigid circuit board is configured in a sheet shape, and the main surface of the rigid circuit board is either of two side plate surfaces; that is, a size of the main surface of the rigid circuit board is a maximum dimension of the rigid circuit board in its extension direction. Therefore, by setting the main surface of the rigid circuit board as parallel as possible to the end surface 2220 of the battery 222, the space utilization rate between the rigid circuit board and the battery 222 can be effectively improved.

Optionally, as shown in FIGS. 6 and 7, in some embodiments, the earphone 1 further includes a microphone 227 and a wearing detection electrode 228 provided in the accommodating cavity 2101. The microphone 227 and the wearing detection electrode 228 may be relatively fixed to the rigid bracket 221 and then, as part of the embedded body 22, embedded in the accommodating cavity 2101 in the manner described above, thereby effectively improving the assembly efficiency of the earphone 1. Specifically, in the embodiment, the first flexible circuit board 2203 further includes a main body circuit board 2203a extending along the axial direction z1 of the battery 222 and connecting the first rigid circuit board 2201 and the second rigid circuit board 2202, and the first flexible circuit board 2203 further includes a first branch circuit board 2203c and a second branch circuit board 2203b. One end of the first branch circuit board 2203c and one end of the second branch circuit board 2203b are located on two opposite sides of the main body circuit board 2203a along a circumferential direction of the battery 222, respectively. Such arrangement allows the first branch circuit board 2203c and the second branch circuit board 2203b to serve as additional circuit boards of the first flexible circuit board 2203 to enhance the functionality of the first flexible circuit board 2203, while the first branch circuit board 2203c and the second branch circuit board 2203b are located along the circumferential direction of the battery 222, which can effectively improve a space utilization rate between the first flexible circuit board 2203 and the battery 222. Furthermore, the other end of the first branch circuit board 2203c is connected to the wearing detection electrode 228, so that the wearing detection electrode 228 may be connected to corresponding circuit elements (for example, a wearing detection circuit) on the rigid circuit board, thereby realizing the wearing detection function of the earphone 1. The other end of the second branch circuit board 2203b is connected to the microphone 227, so that the microphone 227 may be connected to corresponding circuit elements (for example, a microphone processing circuit) on the rigid circuit board, thereby realizing the microphone function of the earphone 1.

Preferably, as shown in FIGS. 6 and 7, in the embodiment, while the first branch circuit board 2203c serves as a part of the first flexible circuit board 2203, an end thereof away from the main body circuit board 2203a extends and expands to form the wearing detection electrode 228 capable of acquiring a wearing detection signal. Thus, a part of the first branch circuit board 2203c can be used as the wearing detection electrode 228, which can effectively improve the part reuse rate of the earphone 1, thereby effectively simplifying an overall structure of the earphone 1 and effectively reducing the manufacturing cost of the earphone 1.

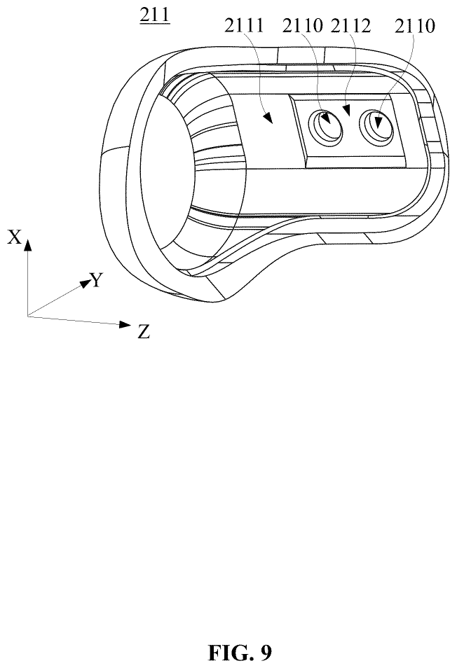

Optionally, as shown in FIGS. 5, 6, 7, and 9, in some embodiments, the embedded body 22 further includes an electrode terminal 226 for supplying power to the battery 222. The battery 222 is connected to the electrode terminal 226, so that the battery 222 may be charged through the electrode terminal 226 and a charging case of the earphone 1, thereby achieving charging of the battery 222. The second housing 211 is provided with a connection through hole 2110, and the electrode terminal 226 is exposed through the connection through hole 2110, so that when the earphone 1 is accommodated in the charging case, the electrode terminal 226 may electrically connect the battery 222 to the charging case. The first side plate 221e is disposed opposite to the connection through hole, and the electrode terminal 226 is disposed on the first side plate 221e. Such arrangement allows the first side plate 221e to support the electrode terminal 226 in the accommodating cavity 2101, to improve the connection stability between the electrode terminal 226 and the second housing 211, and prevent the relative position between the electrode terminal 226 and the second housing 211 from changing due to external factors such as dropping of the earphone 1, which causes poor contact between the electrode terminal 226 and the charging case.

Preferably, as shown in FIGS. 5, 6, 7, and 9, in some embodiments, an inner side of the second housing 211 is provided with a first platform surface 2111 configured as a plane. The connection through hole 2110 is located on the first platform surface 2111. A side of the first side plate 221e facing the first platform surface 2111 is provided with a second platform surface 2214 corresponding to the first platform surface 2111 and configured as a plane. The electrode terminal 226 is located on the second platform surface 2214. The first platform surface 2111 and the second platform surface 2214 are attached to each other. Specifically, after the electrode terminal 226 passes through the connection through hole 2110, a peripheral area of the connection through hole 2110 needs to be sealed to prevent impurities such as sweat, rain, or dust from entering the accommodating cavity 2101 through a gap between the connection through hole 2110 and the electrode terminal 226. Therefore, the first side plate 221e is attached to the first platform surface 2111 on the inner side of the second housing 211 through the second platform surface 2214. This can better seal an area between the second housing 211 and the first side plate 221e, effectively improving the sealing property of the accommodating cavity 2101, and thus effectively improving the working stability of the circuit board assembly 220 and the battery 222. Optionally, in some embodiments, a double-sided tape may be used to seal the area between the second housing 211 and the first side plate 221e. For example, after pasting the double-sided tape on the first platform surface 2111, the first platform surface 2111 with the double-sided tape is pressed against the second platform surface 2214 to achieve sealing.

Optionally, as shown in FIGS. 5, 6, 7, and 9, in some embodiments, the second housing 211 and the first side plate 221e may also be sealed in a dispensing manner. The inner side of the second housing 211 is further provided with a glue accommodating groove 2112 located in the first platform surface 2111 and surrounding the connection through hole 2110. The glue accommodating groove 2112 is used to fill a sealant, so that after the first platform surface 2111 on the inner side of the second housing 211 and the second platform surface 2214 are attached, the sealant can overflow and seal the first platform surface 2111 and the second platform surface 2214, effectively improving the sealing convenience between the second housing 211 and the first side plate 221e while effectively preventing the sealant from dripping onto the circuit board assembly 220 or the battery 222, which affects the performance of the circuit board assembly and the battery 222.

Specifically, in some embodiments, a main surface of the main body circuit board 2203a is disposed opposite to the connection through hole 2110. The main body circuit board 2203a is connected to the electrode terminal 226 to connect to the battery 222. Moreover, the main body circuit board 2203a is at least partially clamped between the first platform surface 2111 and the second platform surface 2214. Such arrangement can effectively improve the sealing property of the accommodating cavity 2101.

Preferably, as shown in FIGS. 6 and 7, in some embodiments, the embedded body 22 further includes two magnetic attraction members 225 disposed on two sides of the electrode terminal 226. When the earphone 1 is placed in the charging case, the two magnetic attraction members 225 may attract corresponding magnetic attraction members in the charging case, so that the electrode terminal 226 can accurately connect to a charging electrode in the charging case while effectively improving the connection stability between the electrode terminal 226 and the charging electrode.

Optionally, as shown in FIGS. 6 and 7, in some embodiments, the two magnetic attraction members 225 may be fixed on the first side plate 221e. Specifically, a side of the first side plate 221e away from the battery accommodating area 2213, is provided with two fixing portions (not labeled) spaced apart along the x1 direction. The two magnetic attraction members 225 are respectively disposed on the two fixing portions to improve the connection stability between the magnetic attraction members 225 and the rigid bracket 221. Optionally, in other embodiments, a fixing portion is respectively formed on the first end plate 221a and the second end plate 221b, and the two magnetic attraction members 225 may also be respectively disposed on the first end plate 221a and the second end plate 221b. Or, in some embodiments, the two fixing portions are respectively formed at a connection between the first side plate 221e and the first end plate 221a and at a connection between the first side plate 221e and the second end plate 221b.

Optionally, as shown in FIGS. 6 and 7, in some embodiments, the earphone 1 further includes an antenna assembly 2230. The antenna assembly 2230 is provided in the accommodating cavity 2101. The antenna assembly 2230 is connected to a radio frequency (RF) unit for transmitting an RF signal to transmit or receive an antenna signal. Preferably, in some embodiments, the antenna assembly 2230 is fixed to the rigid bracket 221 as part of the embedded body 22, and embedded in the accommodating cavity 2101 in the manner described above, thereby effectively improving the assembly efficiency of the earphone 1. The RF unit may be provided on the rigid circuit board to effectively improve the space utilization rate of the earphone 1.

Preferably, as shown in FIGS. 6 and 7, in some embodiments, the antenna assembly 2230 is spaced apart from the battery 222 by a preset interval along an axial direction z1 of the battery 222. Such arrangement can effectively improve the space utilization rate between the battery 222 and the antenna assembly 2230 while effectively reducing the interference of the battery 222 on the antenna assembly 2230, thereby effectively improving the performance of the antenna assembly 2230. Furthermore, a projection of the antenna assembly 2230 along the axial direction z1 of the battery 222 at least partially overlaps an end surface 2220 of the battery 222. This can effectively reduce the spatial occupancy rate of the antenna assembly 2230 in a radial direction of the battery 222, thereby effectively improving the space utilization rate between the antenna assembly 2230 and the battery assembly.

Preferably, as shown in FIGS. 6 and 7, the antenna assembly 2230 includes a first antenna section 223 and a second antenna section 224. The first antenna section 223 and the second antenna section 224 may be connected to the RF unit separately or simultaneously to transmit antenna signals separately or simultaneously. Such arrangement can effectively improve the working stability and the antenna performance of the antenna assembly 2230.

Preferably, in some embodiments, the first antenna section 223 is connected to an RF port of the RF unit, and the second antenna section 224 is grounded (or connected to the ground point). The RF unit simultaneously transmits or receives signals (antenna signals) through the first antenna section 223 and the second antenna section 224. Such arrangement can effectively simplify the circuit structures between the first antenna section 223, the second antenna section 224, and the RF unit. Moreover, after the second antenna section 224 is grounded, it can serve as an antenna branch of the first antenna section 223, and simultaneously transmit or receive signals with the first antenna section 223, thereby further improving the antenna performance of the antenna assembly 2230. Furthermore, after the second antenna section 224 is grounded, it can effectively disperse the current concentrated on the first antenna section 223, thereby preventing the current generated based on the RF signal from being entirely concentrated on the first antenna section 223, and thus effectively reducing the SAR value of the antenna assembly 2230. Moreover, in the embodiment, the earphone 1 includes a left earphone and a right earphone, and the left earphone and the right earphone may be worn in a left-right ear interchangeable wearing manner. When the left earphone and the right earphone are interchanged, a relative positional relationship between the first antenna section 223 and the second antenna section 224 along the gravity direction changes, thereby affecting a clearance rate of the first antenna section 223 and/or a clearance rate of the second antenna section 224, and thus affecting the antenna performance of the first antenna section 223 and/or the second antenna section 224. Therefore, by connecting the first antenna section 223 and the second antenna section 224 to the RF port of the RF unit and the ground point in the above manner, even when the left earphone and the right earphone are interchanged, it can be ensured that at least one of the first antenna section 223 or the second antenna section 224 is located at a position with a better clearance rate and continues to work, thereby effectively ensuring the stability of the antenna function of the antenna assembly 2230 while ensuring the realization of the left-right ear interchangeable function of the earphone 1.

Optionally, in some embodiments, the earphone 1 further includes a switching element (not shown), a detection element (not shown), and a control circuit (not shown). The detection element is configured to detect an operating parameter of the antenna assembly 2230, e.g., a current radiation efficiency of the antenna assembly 2230. Or the detection element may also be used to detect a relative positional relationship between the first antenna section 223 and the second antenna section 224, e.g., a spatial relative positional relationship between the first antenna section 223 and the second antenna section 224 along the gravity direction. Based on this, the control circuit is configured to control, based on a detection result of the detection element, the switching element to selectively connect one of the first antenna section 223 and the second antenna section 224 to an RF port of the RF unit, so that the one of the first antenna section 223 and the second antenna section 224 with the better clearance rate or a better radiation efficiency receives or transmits signals, thereby effectively improving the working stability and the antenna performance of the antenna assembly 2230. For example, in the embodiment, the earphone 1 includes a left earphone and a right earphone, and the left earphone and the right earphone may be worn in a left-right ear interchangeable wearing manner. When the left earphone and the right earphone are interchanged, the relative positional relationship between the first antenna section 223 and the second antenna section 224 changes. At this time, when the detection result of the detection element shows that the first antenna section 223 is located above the second antenna section 224, the clearance rate of the first antenna section 223 is better, and then the control circuit connects the first antenna section 223 to the port of the RF unit based on the detection result, so that the RF unit transmits or receives antenna signals through the first antenna section 223, thereby effectively improving the antenna performance and the working stability of the antenna assembly 2230. Optionally, in some embodiments, the detection element may include a gravity sensing element and other detection components, the switching element may be a logic switching switch and other components, and the control circuit may be a circuit with a certain logic control capability, such as a main control circuit of the earphone 1 or an independent logic processing circuit. The control circuit is connected to the switching element and the detection element respectively to achieve controlling the switching element based on the detection result of the detection element to selectively connect one of the first antenna section 223 and the second antenna section 224 to the RF port of the RF unit. Optionally, in some embodiments, the above functional logic of the switching element, the detection element, and the control circuit may also be independently completed by the main control circuit of the earphone.

Preferably, in some embodiments, an antenna structure of the first antenna section 223 is the same as an antenna structure of the second antenna section 224. Such arrangement ensures that when the relative positional relationship between the first antenna section 223 and the second antenna section 224 changes, the first antenna section 223 or the second antenna section 224 with the better clearance rate can still efficiently perform the antenna function, thereby effectively improving the stability of the antenna assembly 2230, and thus effectively ensuring the antenna performance consistency of the antenna assembly 2230 when the earphone 1 is switched from one ear to the other ear for wearing.

Preferably, in some embodiments, the first antenna section 223 has a first antenna length, and the second antenna section 224 has a second antenna length. A ratio of the first antenna length to the second antenna length is less than or equal to 1.2 and greater than or equal to 0.8. Such arrangement can effectively ensure that the first antenna length and the second antenna length are as equal as possible, to improve the similarity between the first antenna section 223 and the second antenna section 224, and thus effectively ensure the antenna performance consistency of the antenna assembly 2230 when the earphone 1 is switched from one ear to the other ear for wearing.

Preferably, in some implementations, the switching element, the detection element, and the control circuit may be integrated on the first rigid circuit board 2201 or the second rigid circuit board 2202, which can effectively improve the space utilization rate of the earphone 1.

Furthermore, as shown in FIGS. 6 and 7, the first antenna section 223 and the second antenna section 224 are provided at two ends of the battery 222 along the axial direction z1 of the battery 222 at an interval. Projections of the first antenna section 223 and the second antenna section 224 along the axial direction z1 of the battery 222 at least partially overlap the end surface 2220 of the battery 222, respectively. Such arrangement can effectively reduce the spatial occupancy rate of the first antenna section 223 and the second antenna section 224 in a radial direction of the battery 222, thereby effectively improving the space utilization rate between the antenna assembly 2230 and the battery assembly.

Preferably, in some embodiments, projections of the first antenna section 223 and the second antenna section 224 along a radial direction of the battery 222 do not overlap the battery 222, that is, the first antenna section 223 and the second antenna section 224 as a whole are respectively located at two ends of the battery 222 along the axial direction z1. Such arrangement allows the first antenna section 223 and the second antenna section 224 as a whole to maintain a larger interval distance from the battery 222, to effectively reduce the interference of the battery 222 on the antenna assembly 2230, thereby improving the clearance rate of the antenna assembly 2230 while effectively reducing the spatial occupancy rate of the first antenna section 223 and the second antenna section 224 in the radial direction of the battery 222, and thus effectively improving the space utilization rate between the antenna assembly 2230 and the battery assembly.

Preferably, as shown in FIGS. 6 and 7, in some embodiments, in a wearing state, the axial direction z1 of the battery 222 intersects a horizontal plane of the human body. Such arrangement can, in the wearing state, minimize the probability that the first antenna section 223 and the second antenna section 224 are blocked by the head of the user, thereby effectively improving the clearance rate of the first antenna section 223 and the second antenna section 224, and thus effectively improving the antenna performance of the antenna assembly 2230. Preferably, in some embodiments, in the wearing state, the axial direction z1 of the battery 222 may be perpendicular to the horizontal plane of the human body, which can further improve the antenna performance of the antenna assembly 2230.

Preferably, as shown in FIGS. 6 and 7, in some embodiments, a ratio of an area of the first antenna section 223 to a total projection area of the first antenna section 223 along the axial direction z1 of the battery 222 is greater than or equal to 1.2, and a ratio of an area of the second antenna section 224 to a total projection area of the second antenna section 224 along the axial direction z1 of the battery 222 is greater than or equal to 1.2. Such arrangement can effectively reduce the spatial occupancy rate of the first antenna section 223 and the second antenna section 224 along the radial direction of the battery 222, thereby effectively improving the space utilization rate among the first antenna section 223, the second antenna section 224, and the battery 222.

Preferably, in some embodiments, the area of the first antenna section 223 may be equal to the total projection area of the first antenna section 223 along the axial direction z1 of the battery 222, that is, the ratio of the area of the first antenna section 223 to the total projection area of the first antenna section 223 along the axial direction z1 of the battery 222 is equal to 1. The area of the second antenna section 224 may be equal to the total projection area of the second antenna section 224 along the axial direction z1 of the battery 222, that is, the ratio of the area of the second antenna section 224 to the total projection area of the second antenna section 224 along the axial direction z1 of the battery 222 is equal to 1.

Preferably, as shown in FIGS. 6 and 7, in some implementations, each of the first antenna section 223 and the second antenna section 224 is configured in a sheet shape. A main surface of the first antenna section 223 is a maximum extension surface of the first antenna section 223, and a main surface of the second antenna section 224 is a maximum extension surface of the second antenna section 224. The main surface of the first antenna section 223 and the main surface of the second antenna section 224 are disposed to face or away from the end surface 2220 of the battery 222, respectively. Such arrangement can effectively reduce the spatial occupancy rate of the first antenna section 223 and the second antenna section 224 along the axial direction z1 of the battery 222. Furthermore, an included angle between a normal direction of the main surface of the first antenna section 223 and the axial direction z1 of the battery 222, and an included angle between a normal direction of the main surface of the second antenna section 224 and the axial direction z1 of the battery 222 are each less than or equal to 10 degrees. Such arrangement makes the main surface of the first antenna section 223 and the main surface of the second antenna section 224 as parallel as possible to the end surface 2220 of the adjacent battery 222, respectively, thereby further improving the space utilization rate among the battery 222, the first antenna section 223, and the second antenna section 224. For example, in some embodiments, the included angle between the normal direction of the main surface of the first antenna section 223 and the axial direction z1 of the battery 222 and the included angle between the normal direction of the main surface of the second antenna section 224 and the axial direction z1 of the battery 222 may be set to 0°. Preferably, in some embodiments, the normal direction of the main surface of the first antenna section 223 and the normal direction of the main surface of the second antenna section 224 are respectively parallel to the normal direction z2. In other embodiments, the normal direction of the main surface of the first antenna section 223 and the normal direction of the main surface of the second antenna section 224 may also form certain angles with the normal direction z2, respectively.

Preferably, as shown in FIGS. 6 to 8, in some embodiments, the first antenna section 223 is spaced apart from the first rigid circuit board 2201 along the axial direction z1 of the battery 222 on a side of the first rigid circuit board 2201 away from the battery 222. The second antenna section 224 is spaced apart from the second rigid circuit board 2202 along the axial direction z1 of the battery 222 on a side of the second rigid circuit board 2202 away from the battery 222. Such arrangement allows the first rigid circuit board 2201 and the second rigid circuit board 2202 to effectively separate the first antenna section 223 and the second antenna section 224 from the battery 222, respectively, thereby effectively reducing the interference of the battery 222 on the first antenna section 223 and the second antenna section 224, and thus effectively improving the working stability and the antenna performance of the antenna assembly 2230. Furthermore, in some embodiments, the first antenna section 223 is disposed on a side of the third end plate 221c away from the first circuit board accommodating area 2211, and the second antenna section 224 is disposed on a side of the fourth end plate 221d away from the second circuit board accommodating area 2212. Such arrangement can effectively improve the clearance rate of the first antenna section 223 and the second antenna section 224 while further reducing the interference of the battery 222 on the first antenna section 223 and the second antenna section 224, thereby effectively improving the working stability and the antenna performance of the antenna assembly 2230.

Optionally, as shown in FIGS. 6 and 7, in some embodiments, the circuit board assembly 220 further includes a second flexible circuit board 2204 connected to the first rigid circuit board 2201 and a third flexible circuit board 2205 connected to the second rigid circuit board 2202. The second flexible circuit board 2204 is further connected to the first antenna section 223, and the third flexible circuit board 2205 is further connected to the second antenna section 224. The second flexible circuit board 2204 provides circuit routing for the first antenna section 223, so that the first antenna section 223 may be connected to the RF unit on the rigid circuit board. The third flexible circuit board 2205 provides circuit routing for the second antenna section 224, so that the second antenna section 224 may be connected to the RF unit on the rigid circuit board. Such arrangement can effectively improve the connection convenience between the first antenna section 223, the second antenna section 224, and the circuit board assembly 220. Preferably, in some embodiments, an end of the second flexible circuit board 2204 away from the first rigid circuit board 2201 extends to form the first antenna section 223 for receiving or transmitting signals, and an end of the third flexible circuit board 2205 away from the second rigid circuit board 2202 extends to form the second antenna section 224 for receiving or transmitting signals. Such arrangement reuses the second flexible circuit board 2204 and the third flexible circuit board 2205 as the first antenna section 223 and the second antenna section 224, respectively, effectively improving the reuse rate of the circuit board assembly 220, thereby effectively simplifying the structure of the earphone 1 and thus effectively saving the cost of the earphone.

Optionally, in some embodiments, the first antenna section 223 and the second antenna section 224 may be elastic sheet structural members.

Optionally, in some embodiments, the first antenna section 223 and the second antenna section 224 further serve as touch electrodes for receiving touch signals, which can effectively improve reuse rates of the first antenna section 223 and the second antenna section 224, thereby effectively simplifying the overall structure of the earphone 1 and thus effectively reducing the cost of the earphone.

Preferably, as shown in FIG. 2 and FIG. 3, in some embodiments, the speaker module 10 includes a speaker component (not shown) and a second housing assembly. The second housing assembly is configured to form a second accommodating space (not shown). The speaker module is provided in the second accommodating space. The ear-hook portion 30 connects the first housing assembly 21 and the second housing assembly. In a wearing state, the first housing assembly 21 and the second housing assembly form a clamping state on two sides of an auricle, and the second housing assembly is located in a cavitas conchae. The ear-hook portion 30 has a symmetry plane a-a provided along a length direction of the ear-hook portion 30. The axial direction z1 of the battery 222 intersects the symmetry plane a-a. Specifically, in the embodiment, the earphone 1 is an ear-clip earphone, and the symmetry plane a-a of the ear-hook portion 30 serves as the symmetry plane a-a of the earphone 1. In the wearing state, the symmetry plane a-a of the earphone 1 intersects the sagittal plane of the human body, and an included angle between the symmetry plane a-a of the earphone 1 and the sagittal plane of the human body is less than or equal to 90° and greater than or equal to 80°. Such arrangement can effectively ensure that in the wearing state, the axial direction z1 of the battery 222 can intersect the horizontal plane of the human body, thereby effectively improving the clearance rate of the antenna assembly 2230, and thus effectively improving the antenna performance of the antenna assembly 2230.

Furthermore, as shown in FIGS. 2 and 3, the earphone 1 is configured as a symmetrical structure symmetrical with respect to the symmetry plane a-a of the ear-hook portion 30 (at least referring to an overall appearance contour of the earphone 1). Based on this setting, the earphone 1 can be worn in a left-right ear interchangeable wearing manner, and the earphone 1 can ensure good wearing comfort when worn on the left ear or the right ear.

Preferably, as shown in FIGS. 2, 3, 5, and 6, in some embodiments, an antenna structure of the first antenna section 223 is the same as an antenna structure of the second antenna section 224. The first antenna section 223 and the second antenna section 224 are symmetrically provided on two sides of the symmetry plane a-a. Based on this, when the earphone 1 is worn on the left ear or the right ear, it can be ensured that at least one of the first antenna section 223 and the second antenna section 224 has the better clearance rate, thereby effectively improving the stability of the antenna assembly 2230.

Optionally, as shown in FIG. 3, in some embodiments, a maximum dimension d1 of the first housing assembly 21 parallel to the symmetry plane a-a is less than a maximum dimension d2 perpendicular to the symmetry plane a-a. This makes the first housing assembly 21 as a whole configured in an elongated columnar shape, and the maximum dimension d2 of the first housing assembly 21 is perpendicular to the symmetry plane a-a, effectively reducing the spatial occupancy rate of the first housing assembly 21 in the length direction of the ear-hook portion 30, and thereby effectively improving the overall space utilization rate of the earphone 1. Furthermore, a joint seam 213 between the first housing 210 and the second housing 211 intersects the symmetry plane a-a. Such arrangement can effectively increase an opening area of the first opening 2102 of the accommodating cavity 2101, thereby effectively improving the assembly efficiency of embedding the embedded body 22 into the accommodating cavity 2101.

Optionally, as shown in FIG. 5, in some embodiments, the earphone 1 further includes a soft covering layer. The soft covering layer covers a periphery of the ear-hook portion 30 to serve as part of the ear-hook portion 30, and the soft covering layer also covers at least part of a periphery of the first housing assembly 21. Specifically, the soft covering layer covers a periphery of the first housing 210 and the periphery of the ear-hook portion 30. In the wearing state, the first housing 210 abuts against the rear side of the ear through the soft covering layer, thereby effectively improving the wearing comfort of the earphone 1.

Preferably, as shown in FIG. 3, in some embodiments, in the wearing state, the symmetry plane a-a of the earphone 1 intersects the sagittal plane, and an included angle between the symmetry plane a-a of the earphone 1 and the sagittal plane is greater than or equal to 80° and less than or equal to 90°. Such arrangement can effectively ensure that the axial direction z1 of the battery 222 intersects the horizontal plane, thereby effectively improving the clearance rate of the first antenna section 223 and the second antenna section 224, and thus improving the performance of the antenna assembly 2230.

Preferably, as shown in FIG. 3, in some embodiments, in the wearing state, the symmetry plane a-a of the earphone 1 is perpendicular to the sagittal plane, that is, the included angle between the symmetry plane a-a of the earphone 1 and the sagittal plane is set to 90°, and the symmetry plane a-a of the earphone 1 is parallel to the horizontal plane. Such arrangement can further improve the clearance rate of the antenna assembly 2230, thereby further improving the performance of the antenna assembly 2230.

The above are only embodiments of the present disclosure and do not therefore limit the patent scope of the present disclosure. Any equivalent structure or equivalent process transformation made using the content of the description and drawings of the present disclosure, or direct or indirect application in other related technical fields, shall similarly be included within the patent protection scope of the present disclosure.

What is claimed is:

1. An earphone, comprising:
a first housing assembly configured to form a first accommodating space; and
a battery and an antenna assembly provided in the first accommodating space, wherein the antenna assembly is connected to a radio frequency (RF) unit configured to transmit an RF signal, the battery is configured in a columnar shape, the antenna assembly is spaced apart from the battery by a preset interval along an axial direction of the battery, and a projection of the antenna assembly along the axial direction of the battery at least partially overlaps an end surface of the battery.

2. The earphone of claim 1, wherein the antenna assembly includes a first antenna section and a second antenna section, the first antenna section and the second antenna section are provided at two ends of the battery along the axial direction of the battery at an interval, and projections of the first antenna section and the second antenna section along the axial direction of the battery at least partially overlaps the end surface of the battery, respectively.

3. The earphone of claim 2, wherein in a wearing state, the axial direction of the battery intersects a horizontal plane of a human body.

4. The earphone of claim 2, wherein a ratio of an area of the first antenna section and a total projection area of the first antenna section along the axial direction of the battery is greater than or equal to 1.2, and a ratio of an area of the second antenna section and a total projection area of the second antenna section along the axial direction of the battery is greater than or equal to 1.2.

5. The earphone of claim 2, wherein
each of the first antenna section and the second antenna section is configured in a sheet shape;
a main surface of the first antenna section is disposed to face an end surface of the battery adjacent to the first antenna section, and a main surface of the second antenna section is disposed to face an end surface of the battery adjacent to the second antenna section; and
an included angle between a normal direction of the main surface of the first antenna section and the axial direction of the battery, and an included angle between a normal direction of the main surface of the second antenna section and the axial direction of the battery are each less than or equal to 10 degrees.

6. The earphone of claim 2, wherein the first antenna section is connected to an RF port of the RF unit, the second antenna section is grounded, and the RF unit simultaneously transmits or receives signals through the first antenna section and the second antenna section.

7. The earphone of claim 2, further comprising a main control circuit board, wherein the main control circuit board includes a first plate body and a second plate body that are opposite to each other and spaced apart along the axial direction of the battery, the main control circuit board further includes a first flexible circuit board provided around a periphery of the battery along a radial direction of the battery, the first flexible circuit board is at least configured to connect the first plate body and the second plate body to a common ground, the RF unit is provided on the first plate body, the first plate body is provided between the first antenna section and an end surface of the battery adjacent to the first antenna section, the second plate body is provided with a ground point, the second plate body is provided between the second antenna section and an end surface of the battery adjacent to the second antenna section, and the second antenna section is connected to the ground point.

8. The earphone of claim 7, further comprising a second flexible circuit board connected to the first plate body and the first antenna section, and a third flexible circuit board connected to the second plate body and the second antenna section.

9. The earphone of claim 8, wherein an end of the second flexible circuit board away from the first plate body extends to form the first antenna section, and an end of the third flexible circuit board away from the second plate body extends to form the second antenna section.

10. The earphone of claim 7, wherein projections of the first plate body and the second plate body along the axial direction of the battery at least partially overlap the end surface of the battery, and a projection of the first flexible circuit board along the radial direction of the battery at least partially overlaps a peripheral surface of the battery.

11. The earphone of claim 7, wherein a ratio of an area of the first rigid circuit board to a total projection area of the first rigid circuit board along the axial direction of the battery is greater than or equal to 80%, and a ratio of an overlapping area between the second rigid circuit board and the end surface of the battery to a total projection area of the second rigid circuit board along the axial direction of the battery is greater than or equal to 80%.

12. The earphone of claim 7, wherein an included angle between a normal direction of a main surface of the first rigid circuit board and the axial direction of the battery, and an included angle between a normal direction of a main surface of the second rigid circuit board and the axial direction of the battery are both less than or equal to 10°.

13. The earphone of claim 7, wherein the first flexible circuit board includes
a main body circuit board extending along the axial direction of the battery and connecting the first rigid circuit board and the second rigid circuit board; and
a first branch circuit board and a second branch circuit board 2203b, wherein a first end of the first branch circuit board and a first end of the second branch circuit board are located on two opposite sides of the main body circuit board along a circumferential direction of the battery, respectively.

14. The earphone of claim 13, further comprising a microphone and a wearing detection electrode provided in the first accommodating cavity; wherein a second end of the second branch circuit board is connected to the microphone, and a second end of the first branch circuit board is connected to the wearing detection electrode.

15. The earphone of claim 14, wherein from the second end of the first branch circuit board, the first branch circuit board extends and expands along a direction away from the main body circuit board to form the wearing detection electrode.

16. The earphone of claim 13, further comprising an electrode terminal for supplying power to the battery; wherein the main body circuit board is connected to the electrode terminal to connect to the battery.

17. The earphone of claim 2, further comprising a switching element, a detection element, and a control circuit, wherein the detection element is configured to detect an operating parameter of the antenna assembly or detect a relative positional relationship between the first antenna section and the second antenna section, and the control circuit is configured to control, based on a detection result of the detection element, the switching element to selectively connect one of the first antenna section and the second antenna section to an RF port of the RF unit.

18. The earphone of claim 2, further comprising a second housing assembly, an ear-hook portion, and a speaker module, wherein the second housing assembly is configured to form a second accommodating space, the speaker module is provided in the second accommodating space, the ear-hook portion connects the first housing assembly and the second housing assembly, in a wearing state, the first housing assembly and the second housing assembly form a clamping state on two sides of an auricle, the second housing assembly is located in a cavitas conchae, the ear-hook portion has a symmetry plane provided along a length direction of the ear-hook portion, and the axial direction of the battery intersects the symmetry plane.

19. The earphone of claim 18, wherein an antenna structure of the first antenna section is the same as an antenna structure of the second antenna section, and the first antenna section and the second antenna section are symmetrically provided on two sides of the symmetry plane.

20. The earphone of claim 2, wherein the first antenna section has a first antenna length, the second antenna section has a second antenna length, and a ratio of the first antenna length and the second antenna length is less than or equal to 1.2 and greater than or equal to 0.8.
